(19) United States
(12) Patent Application Publication
(10) Pub. No.: US 2016/0196950 A1
(43) Pub. Date: Jul. 7, 2016

(54) X-RAY TUBE ASSEMBLY

(71) Applicants: Kabushiki Kaisha Toshiba, Minato-ku (JP); Toshiba Electron Tubes & Devices Co., Ltd., Otawara-shi (JP)

(72) Inventors: Tomonari Ishihara, Otawara (JP); Hidero Anno, Otawara (JP)

(73) Assignees: Kabushiki Kaisha Toshiba, Minato-ku (JP); Toshiba Electron Tubes & Devices Co., Ltd., Otawara-shi (JP)

(21) Appl. No.: 14/982,489

(22) Filed: Dec. 29, 2015

(30) Foreign Application Priority Data
Jan. 7, 2015 (JP) 2015-001654

(51) Int. Cl. H01J 35/14; H01J 35/08; H01J 35/06

(52) U.S. Cl. CPC H01J 35/14; H01J 35/06; H01J 35/08

(57) ABSTRACT

According to one embodiment, an X-ray tube assembly includes a cathode which emits electrons in an electron orbit direction, an anode target including a target surface with which electrons emitted from the cathode collides to generate X-rays, a vacuum envelope which contains the cathode and the anode target, and in which at least one recessed portion is formed to be recessed from the outside of the vacuum envelope in such a way as to surround the cathode, and a quadrupole magnetic-field generation portion which is provided outside the vacuum envelope, and which comprises four poles provided in the at least one recessed portion such that the cathode is located in a center of an area surrounded by the four poles.

### CROSS-REFERENCE TO RELATED APPLICATIONS

This application is based upon and claims the benefit of priority from Japanese Patent Application No. 2015-001654, filed Jan. 7, 2015, the entire contents of which are incorporated herein by reference.

### FIELD

Embodiments described herein relate generally to an X-ray tube assembly.

### BACKGROUND

A rotation anode X-ray tube assembly is an assembly in which electrons generated from an electron generation source of a cathode are caused to collide with an anode target being rotated, and X-rays are generated from the anode target at the spot of the electrons which is formed by collision of the electrons. In general, the rotation anode X-ray tube assembly is used in an X-ray CT scanner or the like.

In a flying focus (focal spot shift) type of X-ray CT scanner, during X-ray photography, a rotation anode X-ray tube assembly emits X-rays to a subject in such a manner as to form their focal spots in different positions, and the angles of incidence of the X-rays on a detector through the subject are slightly different from each other. As a result, the resolution characteristic of an image obtained by X-ray photography is improved. In such a manner, during X-ray photography, in order that the focal spots of the X-rays emitted from the rotation anode X-ray tube assembly be formed in different positions, it is necessary that the focal spots are slightly shifted intermittently, continuously or periodically for a short time period of 1 msec or less.

In order to do so, some methods are present. As one of the methods, there is provided a magnetic electron-beam deflection system in which an electron beam is deflected by a deflection magnetic field generated by magnetic poles. In the magnetic electron-beam deflection system, a vacuum envelope provided between a cathode and an anode target is made to have a small-diameter portion in which magnetic poles are arranged to generate a deflection magnetic field. In such a magnetic electron-beam deflection system, the distance between the magnetic poles arranged in the small-diameter portion is short, and a magnetic flux density at the electron beam position is high, thus ensuring that the orbit of the electron beam is reliably deflected.

Furthermore, it is known that in the small-diameter portion, four magnetic poles are provided, and a quadrupole magnetic field is generated so that the shape of an electron beam is changed and/or adjusted to magnetically change the size of a formed focal spot.

Also, in the rotation anode X-ray tube assembly, since the vacuum envelope includes the small-diameter portion, the cathode is further separated from the anode target. Furthermore, in the rotation anode X-ray tube assembly, due to provision of the small-diameter portion, the electrical potential distribution is changed, and it is hard to appropriately converge an emitted electron beam. As a result, the following problems can occur: Enlargement, blurring or distortion of the focal spot of an electron beam occurs; and the number of electrons emitted from the cathode is reduced.

In view of the above circumstances, the object of the embodiments is to provide a rotation anode X-ray tube assembly in which the orbit and/or shape of an electron beam emitted from a cathode toward an anode target can be magnetically changed without providing a small-diameter portion in a vacuum envelope, and enlargement, blurring or distortion of the focal spot of an electron beam, and lowering of the number of electrons emitted from the cathode can be reduced.

### BRIEF DESCRIPTION OF THE DRAWINGS

FIG. 1 is a cross-sectional view of an X-ray tube assembly according to a first embodiment.

FIG. 2A is a cross-sectional view schematically showing the X-ray tube.

FIG. 2B is a cross-sectional view taken along line IIA-IIA in FIG. 2A.

FIG. 2C is a cross-sectional view taken along line IIB1-IIB1 in FIG. 2B.

FIG. 2D is a cross-sectional view taken along line IIB2-IIB2 in FIG. 2B.

FIG. 2E is a cross-sectional view taken along line IID-IID in FIG. 2D.

FIG. 3 is a view showing the principle of the quadrupole magnetic-field generation portion according to the first embodiment.

FIG. 4 is a cross-sectional view schematically showing an X-ray tube according to modification according to the first embodiment.

FIG. 5 is a cross-sectional view schematically showing the X-ray tube assembly according to the second embodiment.

FIG. 6A is a cross-sectional view taken along line V-V in FIG. 5.

FIG. 6B is a cross-sectional view taken along line VIA-VIA in FIG. 6A.

FIG. 7 is a view showing the principle of the quadrupole magnetic-field generation portion according to the second embodiment.

FIG. 8 is a cross-sectional view schematically showing an X-ray tube according to modification 1 according to the second embodiment.

FIG. 9 is a view showing the principle of the quadrupole magnetic-field generation portion according to modification.

FIG. 10 is a cross-sectional view schematically showing an X-ray tube according to modification 2 according to the second embodiment.

### DETAILED DESCRIPTION

In general, according to one embodiment, an X-ray tube assembly comprises; a cathode which emits electrons in an electron orbit direction; an anode target provided opposite to the cathode and including a target surface with which electrons emitted from the cathode collides to generate X-rays; a vacuum envelope which contains the cathode and the anode target, which is vacuum-tightly closed, and in which at least one recessed portion is formed to be recessed from the outside of the vacuum envelope to in such a way as to surround the cathode; and a quadrupole magnetic-field generation portion which is supplied with direct current by a DC power supply, and provided outside the vacuum envelope, and which comprises four poles provided in the at least one recessed portion such that the cathode is located in a center of an area surrounded by the four poles.

X-ray tube assemblies according to embodiments will be described in detail with reference to the accompanying drawings.

### First Embodiment

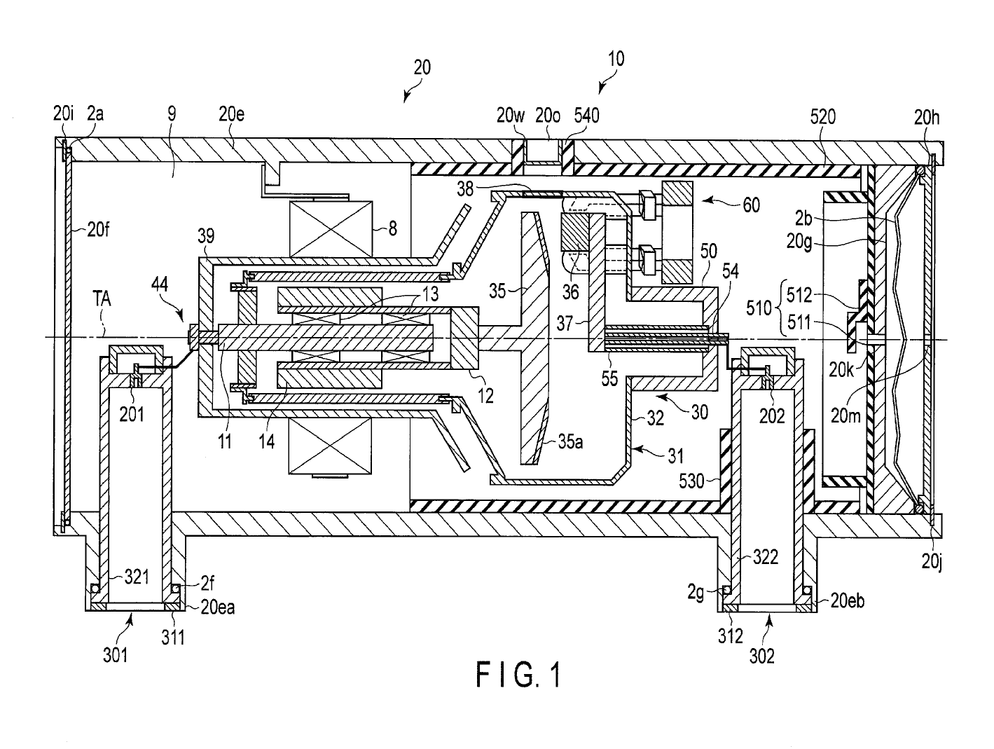

FIG. 1 is a cross-sectional view of an X-ray tube assembly 10 according to a first embodiment.

As shown in FIG. 1, broadly speaking, the X-ray tube assembly 10 according to the first embodiment comprises a stator coil 8, a housing 20, an X-ray tube 30, a high-voltage insulating member 39, a quadrupole magnetic-field generation portion 60, receptacles 301 and 302, and X-ray shielding portions 510, 520, 530 and 540. The X-ray tube assembly 10 is, for example, a rotation anode X-ray tube assembly. The X-ray tube 30 is, for example, a rotation anode X-ray tube. For example, the X-ray tube 30 is, for example, a neutral-point grounded type of X-ray tube. The X-ray shielding portions 510, 520, 530 and 540 are formed of a lead.

In the X-ray tube assembly 10, an insulating oil 9 is filled as a coolant in space provided between an inner portion of the housing 20 and an outer portion of the X-ray tube 30. For example, in the X-ray tube assembly 10, the insulating oil 9 is circulated and cooled by a circulatory cooling system (cooler) (not shown) connected to the housing 20 by hoses (not shown). In this case, the housing 20 includes an intake and an outlet for the insulating oil 9. The circulatory cooling system comprises, for example, a cooler which dissipates heat of the insulating oil 9 in the housing 20 and circulates the insulating oil 9, and pipes (hoses or the like) which liquid-tightly and airtightly connects the cooler to the intake and the outlet of the housing 20. The cooler includes a circulating pump and a heat exchanger. The circulating pump discharges insulating oil 9 taken from a housing side into the heat exchanger, and produces a flow of insulating oil 9 in the housing 20. The heat exchanger is connected between the housing 20 and the circulating pump, and radiates heat of the insulating oil 9 to the outside.

The structure of the X-ray tube assembly 10 will be explained in detail with reference to the accompanying drawings.

The housing 20 comprises a cylindrical main body 20e and lid portions (side plates) 20f, 20g and 20h. The main body 20e and the lid portions 20f, 20g and 20h are formed of an aluminum casting. If the main body 20e and the lid portions 20f, 20g and 20h are formed of resin material, the following portions of them may be formed of metal: a portion which needs to have a given strength, such as a screw portion; a portion which cannot be easily formed by injection molding of resin; and a shielding layer (not shown) which prevents leakage of an electromagnetic noise from the housing 20 to the outside thereof. In the following description, the central axis of the cylindrical main body 20e is referred to as a tube axis TA.

In an opening portion of the main body 20e, an annular step portion is formed in an inner peripheral surface of the main body 20e, and has a thickness less than the thickness of the main body 20e. Also, an annular groove portion is formed in an inner peripheral surface of the above step portion. The groove portion of the main body 20e is cut and formed outwards from a step of the step portion to a location separated therefrom by a predetermined distance along the tube axis TA. The predetermined distance is, for example, nearly equal to the thickness of the lid portion 20f. In the groove portion of the main body 20e, a C-type snap ring 20i is fitted. That is, the opening portion of the part of the main body 20e is liquid-tightly closed by the lid portion 20f, the C-type snap ring 20i, etc.

The lid portion 20f is formed discoid. The lid portion 20f includes a rubber member 2a provided along an outer peripheral portion of the lid portion 20f, and is engaged with the step portion formed in the opening portion of part of the main body 20e.

The rubber member 2a is formed in the shape of an O-ring. As described above, the rubber member 2a is provided between the main body 20e and the lid portion 20f, and liquid-tightly seals space between them. In a direction along the tube axis TA of the X-ray tube assembly 10, a peripheral edge portion of the lid portion 20f is in contact with the step portion of the main body 20e.

Furthermore, a C-type snap ring 20i is provided as a fixing member. To be more specific, in order to stop movement of the lid portion 20f along the tube axis TA, the C-type snap ring 20i is fitted in the groove portion of the main body 20e, thereby fixing the lid portion 20f.

In an opening portion of the main body 20e which is located opposite to the opening portion where the lid portion 20f is provided, the lid portions 20g and 20h are fitted. To be more specific, the lid portions 20g and 20h are provided at an end portion of the main body 20e which is located opposite to an end portion thereof at the lid portion 20f; and they are also located parallel to and opposite to the lid portion 20f. The lid portion 20g is fitted in a predetermined position in the inside of the main body 20e, and liquid-tightly provided. At the end portion of the main body 20e, at which the lid portion 20h is provided, an annular groove portion is formed at an inner peripheral portion outwardly adjacent to the set position of the lid portion 20h. Between the lid portions 20g and 20h, a rubber member 2b is provided in such a manner as to be expandable and liquid-tightly held. The lid portion 20h is located outward of the lid portion 20g in the main body 20e. In a groove portion formed in the vicinity of the lid portion 20h, a C-type snap ring 20j is fitted. That is, the opening portion of the main body 20 is liquid-tightly closed by the lid portions 20g and 20h, the C-type snap ring 20j, the rubber member 2b, etc.

The lid portion 20g is circularly formed to have a diameter which is nearly equal to the inside diameter of the main body 20e. The lid portion 20g includes an opening portion 20k for entry or exit of insulating oil 9.

The lid portion 20h is circularly formed to have a diameter which is nearly equal to the inside diameter of the main body 20e. The lid portion 20h is formed to include an air hole 20m for entry or exit of air which is used as an atmosphere.

The C-type snap ring 20j is a fixing member which holds the lid portion 20h in tight contact with a peripheral portion (seal portion) of the rubber member 2b.

The rubber members 2b is a rubber bellows (rubber film). The rubber member 2b is formed circularly. Furthermore, the peripheral portion (seal portion) of the rubber member 2b is formed in the shape of an O-ring. The rubber member 2b is provided in space between the lid portion 20h and the lid portion 20g of the main body 20e, and liquid-tightly seals the space. Also, the rubber member 2b is provided along an inner periphery of an end portion of the main body 20e. That is, the rubber member 2b is provided in such a manner as to partition part of space in the housing. In the first embodiment, the rubber member 2b is provided in space defined by the lid portions 20g and 20h, and liquid-tightly partitions the space into two regions. In the following, the space defined by the rubber member 2b and the lid portion 20g is referred to as first space, and that defined by the rubber member 2b and the lid portion 20h is referred to as second space. The first space communicates with space in the main body 20e which is filled with insulating oil 9, through the opening portion 20k. Thus, the first space is filled with insulating oil 9. The second space communicates with external space through an air hole 20m. Thus, the second space is filled with atmospheric air.

The main body 20e includes an opening portion 20o which penetrates part of the main body 20e. In the opening portion 20o, an X-ray emission window 20w and an X-ray shielding portion 540 are provided. Also, the opening portion 20o is liquid-tightly closed by the X-ray emission window 20w and the X-ray shielding portion 540. The X-ray shielding portions 520 and 540 are provided to prevent X-ray leakage (that is X-rays which radiate through the region out of the X-ray emission window 20w into the outside of the housing 20). This will be explained later in detail.

The X-ray emission window 20w is formed of a material which permits X-rays to easily pass therethrough. For example, the X-ray emission window 20w is formed of metal which is highly X-ray transmissive.

The X-ray shielding portions 510, 520, 530 and 540 have only to be formed of an X-ray impermeable material containing at least a lead, and may be formed of, for example, a lead alloy.

The X-ray shielding portion 510 is provided on an inner surface of the lid portion 20g. The X-ray shielding portion 510 blocks X-rays radiated from the X-ray tube 30. Also, the X-ray shielding portion 510 includes a first shielding portion 511 and a second shielding portion 512. The first shielding portion 511 is joined to the inner surface of the lid portion 20g. Also, the first shielding portion 511 is provided to cover the entire inner surface of the lid portion 20g. Furthermore, one of end portions of the second shielding portion 512 is provided on an inner surface of the first shielding portion 511, and the other is spaced from the opening portion 20k toward an inner surface of the main body 20e. That is, the second shielding portion 512 is provided such that insulating oil 9 can enter or exit the housing 20 through the opening portion 20k.

The X-ray shielding portion 520 is formed substantially cylindrically. Also, the X-ray shielding portion 520 is provided on part of an inner peripheral portion of the main body 20e. One end portion of the X-ray shielding portion 520 is located close to the first shielding portion 511. It is therefore possible to block X-rays which may be emitted from the gap between the X-ray shielding portions 510 and 520. The X-ray shielding portion 520 is formed cylindrically, and extends along the tube axis from the first shielding portion 511 to the vicinity of the stator coil 8. To be more specific, in the first embodiment, the X-ray shielding portion 520 extends from the first shielding portion 511 to a position located just before the stator coil 8. Furthermore, the X-ray shielding portion 520 is fixed to the housing 20 as occasion demands.

The X-ray shielding portion 530 is formed cylindrically, and fitted along an outer periphery of part of the receptacle 302 which is located in the housing 20. The receptacle 302 will be described later. One cylindrical end portion of the X-ray shielding portion 530 is provided in contact with a wall surface of the main body 20e. At this time, the X-ray shielding portion 520 includes a hole through which the end portion of the X-ray shielding portion 530 is inserted. The X-ray shielding portion 530 is fixed to the X-ray shielding portion 520 as occasion demands.

The X-ray shielding portion 540 is formed in the shape of a frame, and provided at a side edge of the opening portion 20o of the housing 20. The X-ray shielding portion 540 is provided along an inner wall of the opening portion 20o. An end portion of the X-ray shielding portion 540 which is located on an inner side of the main body 20e is in contact with the X-ray shielding portion 520. The X-ray shielding portion 540 is fixed to the side edge of the opening portion 20o as occasion demands.

The receptacle 301 is a receptacle for an anode, and the receptacle 302 is a receptacle for a cathode; and they are connected to the main body 20e. The receptacles 301 and 302 are each formed in the shape of a cylinder having an opening portion and a bottom. The bottoms of the receptacles 301 and 302 are located in the housing 20, and the opening portions of them are open to the outside of the housing 20. For example, in the main body 20e, the receptacles 301 and 302 are spaced from each other by a predetermined distance, and their opening portions faces in the same direction.

Plugs (not shown) to be inserted into the receptacles 301 and 302 are of a non-contact pressure type, and are formed insertable and removable into and from the receptacles. With the plugs inserted in the receptacle 301, a high voltage (for example, +70 to +80 kV) is applied from the plugs to a terminal 201.

In the housing 20, the receptacle 301 is located close to the lid portion 20f and inward of the lid portion 20f. The receptacle 301 includes a housing 321 and the terminal 201, the housing 321 also serving as an electrically insulating member, the terminal 201 serving as a high-voltage application terminal.

The housing 321 is formed of an insulating material such as resin. To be more specific, the housing 321 is formed in the shape of a cylinder having a bottom and a jack for plug, which is open to the outside of the housing 20. A bottom portion of the housing 321 is provided with the terminal 201. At an end portion of the housing 321 which is open, an annular projecting portion is formed at an outer surface of the end portion. The projecting portion of the housing 321 is formed to be fitted in a step portion 20ea formed in an end portion of a projecting portion of the main body 20e. The terminal 201 is liquid-tightly attached to the bottom portion of the housing 321 in such a manner as to penetrate the bottom portion. The terminal 201 is connected to a high-voltage application terminal 44 to be described later by an insulating coated line.

Furthermore, between the projecting portion of the housing 321 and the main body 20e, a rubber member 2f is provided. The rubber member 2f is located between the projecting portion of the housing 321 and a step of the step portion 20ea, and liquid-tightly seals the gap between the projecting portion of the housing 321 and the main body 20e. In the first embodiment, the rubber member 2f is formed in the shape of an O-ring. The rubber member 2f prevents insulating oil 9 from leaking from the housing 20 to the outside thereof. The rubber member 2f is formed of, for example, a sulfur vulcanized rubber.

The housing 321 is fixed by a ring nut 311. The ring nut 311 has an outer peripheral portion in which a screw groove is formed. For example, the outer peripheral portion of the ring nut 311 is processed into a male screw, and an inner peripheral portion of the step portion 20ea is processed into a female screw. Therefore, when the ring nut 311 is screwed, the projecting portion of the housing 321 is pressed against the step portion 20ea, with the rubber member 2f interposed between them. As a result, the housing 321 is fixed to the main body 20e.

In the housing 20, the receptacle 302 is located close to the lid portion 20g and inward of the lid portion 20g. The receptacle 302 is formed in substantially similar manner as the receptacle 301. To be more specific, the receptacle 302 includes a housing 322 also serving as an electrically insulating member and a terminal 202 serving as a high-voltage application terminal.

The housing 322 is formed of an insulating material such as resin. The housing 322 is formed in the shape of a cylinder having a bottom and a jack for plug, which is open to the outside of the housing 20. A bottom portion of the housing 322 is provided with the terminals 202. At an open end portion of the housing 322, an annular projecting portion is formed at an outer surface of the end portion. The projecting portion of the housing 322 is formed to be fitted in a step portion 20eb formed in an end portion of another projecting portion of the main body 20e. The terminals 202 are liquid-tightly attached to the bottom portion of the housing 322 in such a manner as to penetrate the bottom portion. The terminals 202 are connected to a high-voltage application terminal 54 to be described later by insulating coated lines.

Furthermore, between the projecting portion of the housing 322 and the main body 20e, a rubber member 2g is provided. The rubber member 2g is located between the projecting portion of the housing 322 and a step of the step portion 20eb, and liquid-tightly seals the gap between the projecting portion of the housing 322 and the main body 20e. In the first embodiment, the rubber member 2g is formed in the shape of an O-ring. The rubber member 2g prevents insulating oil 9 from leaking from the housing 20 to the outside thereof. The rubber member 2g is formed of, for example, a sulfur vulcanized rubber.

The housing 322 is fixed by a ring nut 312. The ring nut 312 has an outer peripheral portion in which a screw groove is formed. For example, the outer peripheral portion of the ring nut 312 is processed into a male screw, and an inner peripheral portion of the step portion 20ea is processed into a female screw. Therefore, when the ring nut 312 is screwed, the projecting portion of the housing 322 is pressed against the step portion 20eb, with the rubber member 2g interposed between them. As a result, the housing 322 is fixed to the main body 20e.

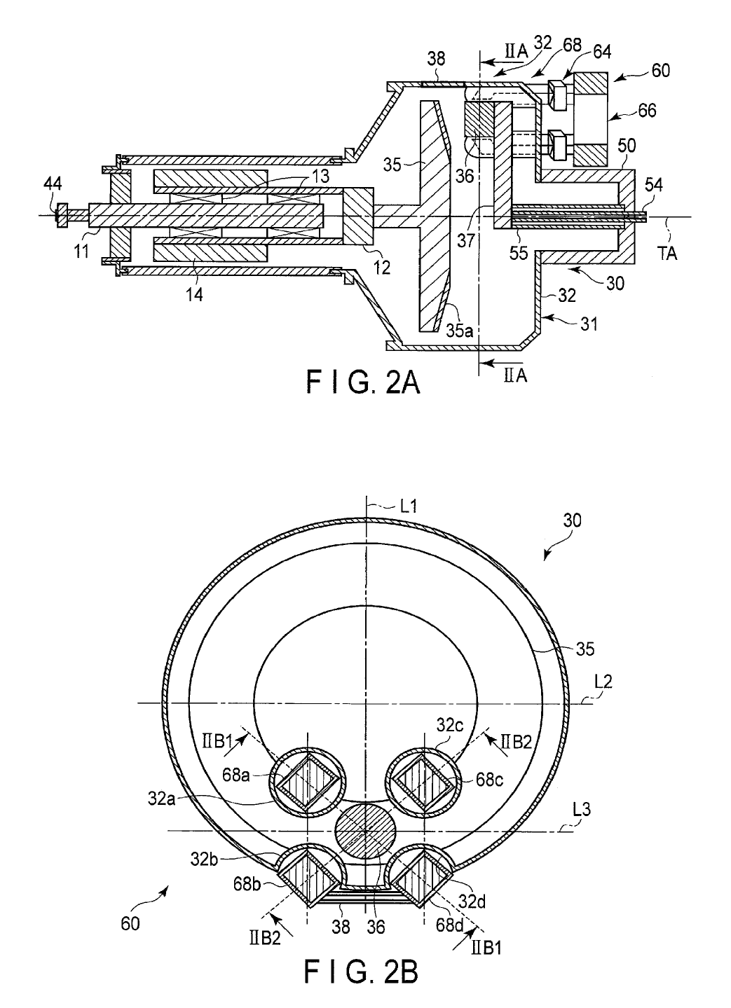

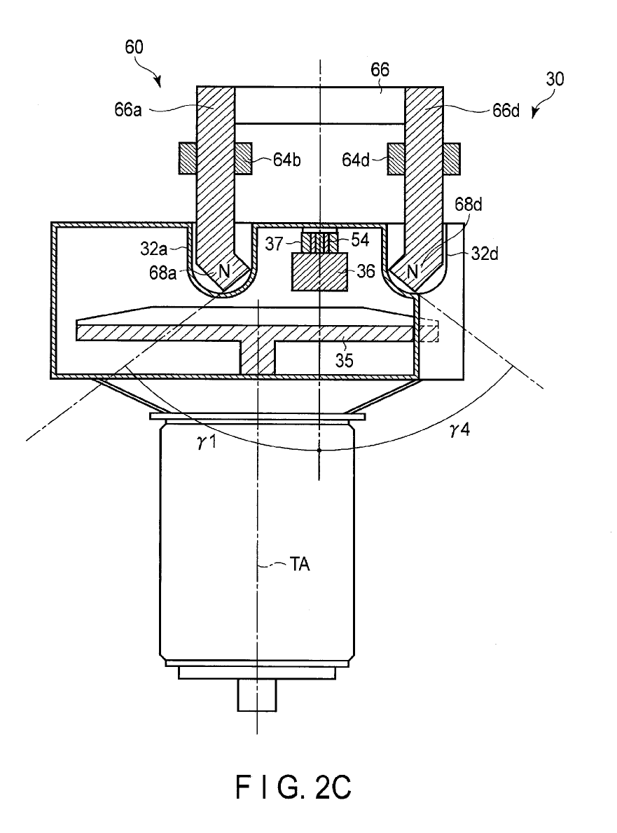

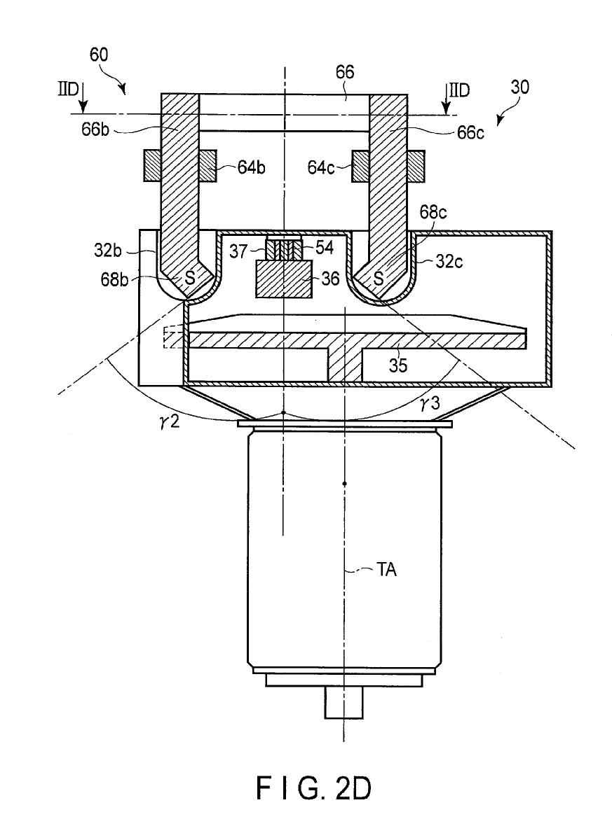

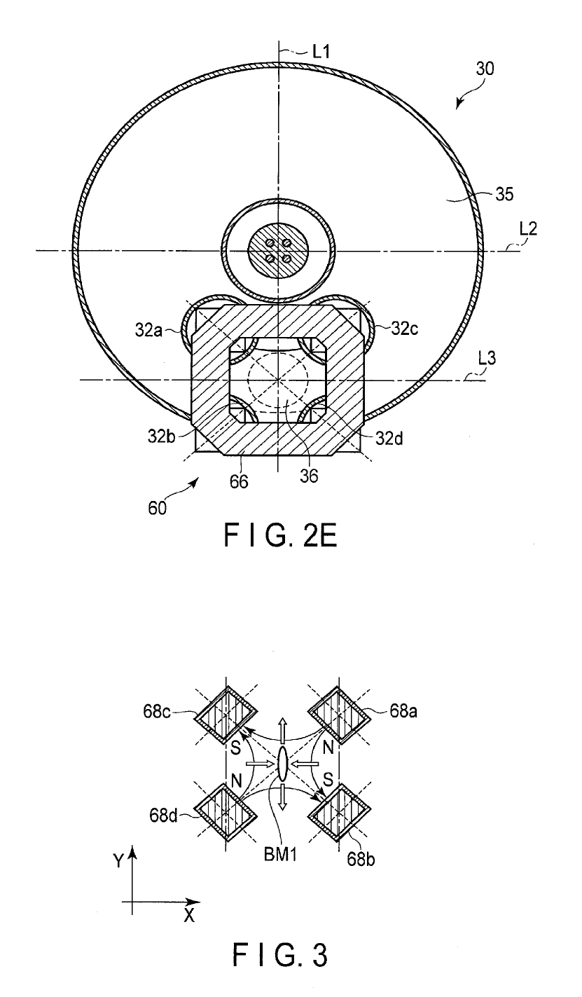

FIG. 2A is a cross-sectional view schematically showing the X-ray tube 30; FIG. 2B is a cross-sectional view taken along line IIA-IIA in FIG. 2A; FIG. 2C is a cross-sectional view taken along line IIB1-IIB1 in FIG. 2B; FIG. 2D is a cross-sectional view taken along line IIB2-IIB2 in FIG. 2B; and FIG. 2E is a cross-sectional view taken along line IID-IID in FIG. 2D. In FIG. 2B, a line perpendicular to the tube axis TA is line L1, and a line perpendicular to both the tube axis TA and line L1 is line L2.

The X-ray tube 30 comprises a fixed shaft 11, a rotating body 12, bearings 13, a rotor 14, a vacuum envelope 31, an anode target 35, a cathode 36, a high-voltage application terminal 44, a high-voltage application terminals 54 and a KOV member 55. In FIG. 2B, a line, which is perpendicular to a central line extending from the center the cathode 36 or to a line extending along the traveling direction of an electron beam, and which is parallel to line L2, is L3.

The fixed shaft 11 is cylindrically formed. The fixed shaft 11 supports the rotating body 12 in such a way as to allow the rotating body 12 to be rotated, with the bearing 13 interposed between the fixed shaft 11 and the rotating body 12. An end portion of the fixed shaft 11 is provided with a projecting portion vacuum-tightly attached to the vacuum envelope 31. The projecting portion of the fixed shaft 11 is fixed to the high-voltage insulating member 39. In this case, a distal end portion of the projecting portion of the fixed shaft 11 penetrates the high-voltage insulating member 39. Also, the distal end portion of the projecting portion of the fixed shaft 11 is electrically connected to the high-voltage application terminal 44.

The rotating body 12 is formed in the shape of a cylinder having a bottom. In the rotating body 12, the fixed shaft 11 is inserted. Also, the rotating body 12 is provided coaxial with the fixed shaft 11. The rotating body 12 includes on its bottom side a distal end portion connected to the anode target 35, which will be described later. The rotating body 12 is provided rotatable along with the anode target 35.

The bearings 13 are provided between an inner peripheral portion of the rotating body 12 and an outer peripheral portion of the fixed shaft 11.

The rotor 14 is provided within the stator coil, which is cylindrically formed.

The high-voltage application terminal 44 applies a relatively positive voltage to the anode target 35 through the fixed shaft 11, the bearings 13 and the rotating body 12. The high-voltage application terminal 44 is connected to the receptacle 301, and is supplied with current when a high-voltage application source such as a plug not shown is connected to the receptacle 301. The high-voltage application terminal 44 is a metal terminal.

The anode target 35 is formed discoid. The anode target 35 is connected to the distal end portion of the rotating body 12 on the bottom side thereof, and is provided coaxial with the rotating body 12. For example, the rotating body 12 and the anode target 35 are provided such that their central axes are parallel to the tube axis TA. In this case, the rotating body 12 and the anode target 35 are provided rotatable around the tube axis TA.

The anode target 35 includes a target layer 35a formed in the shape of an umbrella and provided at part of an outer surface of the anode target. The target layer 35a emits X-rays when electrons emitted from the cathode 36 collide with the target layer 35a. An outer side surface of the anode target 35 and a surface of the anode target 35, which is located opposite to the target layer 35a, are subjected to blacking processing. The anode target 35 is formed of a material which is non-magnetic and has high electrical conductivity (a good electrical conducting property). For example, the anode target 35 is formed of copper, tungsten, molybdenum, niobium, tantalum, a non-magnetic stainless steel, titanium or chromium. In this regard, it suffice that at least a surface portion of the anode target 35 is formed of a metallic material which has high electrical conductivity and is non-magnetic. Therefore, for example, the entire anode target 35 may be formed of a metallic material which has a high electrical conductivity and is non-magnetic. Alternatively, the surface portion of the anode target 35 may be coated with a coating member formed of a metallic material which has high electrical conductivity and is non-magnetic.

The cathode 36 includes a filament (electron emission source) which emits an electron beam. The cathode 36 is located opposite to the target layer 35a. The cathode 36 emits electrons to the anode target 35. For example, the cathode 36 is cylindrically formed, and emits electrons from the filament to the surface of the anode target 35, the filament being located on a central line extending through the center of the cylindrically formed cathode 36. At this time, the central line extending through the center of the cathode 36 is nearly parallel to the tube axis TA. In the following description, there is a case where the traveling direction of electrons emitted from the cathode 36 is referred to as an “electron orbit”. To the cathode 36, a relatively negative voltage is applied. The cathode 36 is attached to a cathode supporting portion (a cathode supporter or a cathode support member) 37 to be described later, and is connected to the high-voltage application terminals 54, which extends in the cathode supporting portion 37. It should be noted that there is a case where the cathode 36 is referred to as an electron emission source. Furthermore, the following explanation is given on the premise that part of the cathode 36 which emits an electron beam is located at the center of the cathode 36. Also, in the following explanation, there is a case where the center of the cathode 36 means a center portion of the cathode which extends through the center thereof.

The cathode 36 includes a non-magnetic cover covering the entire outer periphery of the cathode 36. The non-magnetic cover is cylindrically formed and provided to surround the periphery of the cathode 36. The non-magnetic cover is formed of any of, for example, copper, tungsten, molybdenum, niobium, tantalum, a non-magnetic stainless steel, titanium and chromium, or a non-magnetic metallic material such as a metallic material containing as its main ingredient, any of copper, tungsten, molybdenum, niobium, tantalum, a non-magnetic stainless steel, titanium and chromium. It is preferable that the non-magnetic cover is formed of a material having a high electrical conductivity. In the case where the non-magnetic cover is provided in an AC magnetic field, and the electrical conductivity of the non-magnetic cover is high, the non-magnetic cover can cause magnetic lines of force to be further strongly distorted because of an opposite AC magnetic field based on an eddy current, than in the case where the electrical conductivity of the non-magnetic cover is low. In such a manner, if the lines of magnetic force are distorted, they flow along the periphery of the cathode 36, and a magnetic field (AC magnetic field) close to the surface of the cathode 36 is enhanced. As a result, the cathode 36 can raise a deflecting force of the quadrupole magnetic-field generation portion 60 for electrons, which will be described later. It should be noted that it suffices that at least a surface portion of the cathode 36 is formed of a metallic material which has high electrical conductivity and is non-magnetic. Therefore, for example, the entire cathode 36 may be formed of a metallic material which has high electrical conductivity and is non-magnetic.

Furthermore, although the cathode 36 includes the non-magnetic cover covering the entire outer periphery of the cathode 36 as described above, the entire cathode 36 may be formed of a non-magnetic member or metal which is non-magnetic and has high electrical conductivity.

At one of end portions of the cathode supporting portion 37, the cathode 36 is provided, and at the other end portion of the cathode supporting portion 37, a KOV member 55 is provided. Also, in the cathode supporting portion 37, the high-voltage application terminals 54 are provided. As shown in FIG. 2A, the cathode supporting portion 37 is provided to extend from part of the KOV member 55 which is located in the vicinity of the tube axis TA to the vicinity of the outer periphery of the anode target 35. Furthermore, the cathode supporting portion 37 is provided in nearly parallel with the anode target 35 and separated therefrom by a predetermined distance. The above one of the end portions of the cathode supporting portion 37 at which the cathode 36 is provided is closer to the outer periphery of the anode target 35 than the other end portion. It should be noted that the periphery of the cathode supporting portion 37 may be covered by the non-magnetic cover or at least the surface portion of the cathode supporting portion 37 may be formed of a metallic material which has a high electrical conductivity and is non-magnetic.

The KOV member 55 is formed of a low-thermalexpansion alloy. One of end portions of the KOV member 55 is joined to the cathode supporting portion 37, and the other is jointed to a high-voltage insulating member 50. The KOV member 55 covers the high-voltage application terminals 54 in the vacuum envelope 31, which will be described later.

The high-voltage application terminals 54 are joined to the high-voltage insulating member 50 by brazing. The high-voltage application terminals 54 are provided to penetrate the high-voltage insulating member 50 and inserted in the vacuum envelope 31. In this case, the inserted parts of the high-voltage application terminals 54 are vacuum-tightly closed in the vacuum envelope 31.

Also, the high-voltage application terminals 54 are provided to extend in the cathode supporting portion 37 and connected to the cathode 36. The high-voltage application terminals 54 apply a relatively negative voltage to the cathode 36, and supply a filament current to the filament (electron generation source), not shown, in the cathode 36. Furthermore, the high-voltage application terminals 54 are connected to the receptacle 302, and are supplied with current when a high-voltage application source such as a plug not shown is connected to the receptacle 302. The high-voltage application terminals 54 are metal terminals.

The vacuum envelope 31 is closed in a vacuum atmosphere (vacuum-tight), and accompanies the fixed shaft 11, the rotation body 12, the bearings 13, the rotor 14, the anode target 35, the cathode 36, the high-voltage application terminals 54 and the KOV member 55. The vacuum vessel 32 as a component of the vacuum envelope 31, encloses the cathode 36 and the anode target 35.

The vacuum vessel 32 includes an X-ray transmission window 38 which is vacuum-tightly provided therein. The X-ray transmission window 38 is provided at a wall portion of the vacuum vessel 32, which is located opposite to a region between the cathode 36 and the anode target 35. The X-ray transmission window 38 is formed of metal, for example, beryllium, titanium, stainless or aluminum, and is located opposite to the X-ray emission window 20w. For example, the vacuum vessel 32 is vacuum-tightly closed in the X-ray transmission window 38, which is formed of beryllium used as a material which permits X-rays to be transmitted therethrough. Outside the vacuum envelope 31, the high-voltage insulating member 39 is provided from a side where the high-voltage application terminal 44 is located to the vicinity of the anode target 35. The high-voltage insulating member 39 is formed of resin having an electrically insulating property.

The vacuum vessel 32 includes a recessed portion which accommodates a distal end portion of the quadrupole magnetic-field generation portion 60, which will be described later. As shown in FIG. 2B, in the first embodiment, the vacuum vessel 32 includes a plurality of recessed portions 32a, 32b, 32c and 32d. The recessed portions 32a, 32b, 32c and 32d are formed in respective portions of the vacuum vessel 32. That is, the recessed portions 32a, 32b, 32c and 32d are portions of the vacuum vessel 32, which surrounds the recesses. For example, the recessed portions 32a to 32d are formed by concaving the vacuum vessel 32 in such a manner to surround the cathode 36 in a direction perpendicular to the traveling direction of an electron beam. That is, as seen from the inside of the vacuum vessel 32, the recessed portions 32a to 32d are formed to project in a direction parallel to the traveling direction of an electron beam emitted from the cathode 36. For example, in the vicinity of the cathode 36, the recessed portions 32a to 32d are arranged at regular intervals, and formed in such a manner to be inclined at the same angle around the center of the cathode 36. In this case, the recessed portion 32b is provided in a location rotated from the recessed portion 32a by 90° around the center of the cathode 36. Similarly, the recessed portion 32d is provided in a location rotated from the recessed portion 32b by 90° in its rotation direction around the center of the cathode 36, and the recessed portion 32c is provided in a location rotated from the recessed portion 32d by 90° in its rotation direction around the center of the cathode 36.

For example, as shown in FIG. 2B, the recessed portion 32a is provided on a line rotated from line L3 or L1 by 45° around the center of the cathode 36; the recessed portion 32b is provided on a location rotated from the recessed portion 32a by 90° in its rotation direction around the center of the cathode 36; the recessed portion 32d is provided in a location rotated from the recessed portion 32b by 90° in its rotation direction around the center of the cathode 36; and the recessed portion 32c is provided in a location rotated from the recessed portion 32d by 90° in its rotation direction around the center of the cathode 36. That is, the recessed portions 32a to 32d are located on vertices of a square, respectively.

Also, the recessed portions 32a to 32d are formed such that they are located not too close to the surface of the anode target 35 and the surface of the cathode 36 in order to prevent occurrence of discharge or the like. For example, the recessed portion 32a is formed to be recessed to a position which is located further away from a surface of the anode target 35 than a surface of the cathode 36, which is located opposite to the surface of the anode target 35, in the tube axis TA. Alternatively, the recessed portion 32a is formed to be recessed to a position which is slightly closer to the surface of the anode target 35 than the surface of the cathode 36, along the tube axis TA. In order to prevent occurrence of discharge or the like, corner portions of the recessed portions 32a to 32d which project toward the surface of the anode target 35 are curved or inclined such that they are separated from the surface of the anode target 35 and the surface of the cathode 36. For example, as shown in FIGS. 2C and 2D, the corner portions of the recessed portions 32a to 32d are curved. It should be noted that the corner portions of the recessed portions 32a to 32d may be inclined at an angle corresponding to an inclination angle of each of magnetic poles 68 (68a, 68b, 68c and 68d) which will be described later. Also, the corner portions of the recessed portions 32a to 32d which project toward the anode target 35 need not always to be inclined or have a diameter.

Furthermore, only a single recessed portion may be provided if the above magnetic poles are provided in a direction perpendicular to a line extending along the traveling direction of an electron beam emitted from the cathode, and are also provided around the above axis such that they are inclined at the same angle with respect to the above line. For example, the recessed portions 32a to 32d may be formed as a single body. Furthermore, the recessed portions 32a and 32b may be formed as a single body, and the recessed portions 32c and 32d may also be formed as a single body.

The vacuum vessel 32 captures recoil electrons reflected from the anode target 35. Thus, the temperature of the vacuum vessel 32 easily rises because of an impact of the recoil electrons. Accordingly, generally, the vacuum vessel 32 is formed of a material having a high thermal conductivity. If the vacuum vessel 32 is influenced by an alternating magnetic field, it is preferable that the vessel 32 be formed of a material which does not generate a demagnetizing field. For example, the vacuum vessel 32 is formed of a metallic material which is non-magnetic. Also, it is preferable that the vacuum vessel 32 be formed of a non-magnetic material having high electrical resistance in order to prevent eddycurrent from being generated by an alternating magnetic field. The non-magnetic material having high electrical resistance is, for example, a non-magnetic stainless steel, Inconel, Inconel X, titanium, a conductive ceramics, a non-conductive ceramics having a surface coated with a metallic thin film or the like. It is more preferable that in the vacuum vessel 32, the recessed portions 32a to 32d be formed of a non-magnetic material having high electrical resistance, and part of the vacuum envelope 31 which is other than the recessed portions 32a to 32d be formed of a non-magnetic material having a high thermal conductivity such as copper.

One of the ends of the high-voltage insulating member 39 is conic, and the other is closed and annular. The high-voltage insulating member 39 is directly fixed to the housing 20 or indirectly fixed to the housing 20, with the stator coil 8 or the like, which will be described later, interposed between them. The high-voltage insulating member 39 electrically insulates the fixed shaft 11 from the housing 20 and the stator coil 8. Thus, the high-voltage insulating member 39 is provided between the stator coil 8 and the fixed shaft 11. To be more specific, the high-voltage insulating member 39 is provided to accommodate part (the vacuum vessel 32) of the X-ray tube 30 which is located on a projecting portion side of the fixed shaft 11 in the X-ray tube 30.

Re-referring to FIG. 1, a plurality of portions of the stator coil 8 are fixed to the housing 20. The stator coil 8 is provided in such a manner as to surround the outer peripheries of the rotor 14 and the high-voltage insulating member 39. The stator coil 8 rotates the rotor 14, the rotating body 12 and the anode target 35. When the stator coil 8 is supplied with predetermined current, it generates a magnetic field to be applied to the rotor 14, and thus rotates the anode target 35, etc., at a predetermined speed. That is, when current is supplied to the stator coil 8, which is a rotary drive device, the rotor 14 is rotated, and the anode target 35 is also rotated in accordance with the rotation of the rotor 14.

In the housing 20, insulating oil 9 is filled in space surrounded by the rubber member 2b, the main body 20e, the lid portion 20f, the receptacle 301 and the receptacle 302. The insulating oil 9 absorbs at least part of heat generated from the X-ray tube 30.

With reference to FIGS. 2A to 2D, the quadrupole magnetic-field generation portion 60 will be explained.

As shown in FIGS. 2C and 2D, the quadrupole magnetic-field generation portion 60 comprises coils 64 (64a, 64b, 64c and 64d), a yoke 66 (which comprises projecting portions 66a, 66b, 66c and 66d) and the magnetic poles 68 (68a, 68b, 68c and 68d).

The quadrupole magnetic-field generation portion 60 is formed of four magnetic poles (or quadrupole) which are arranged close to each other such that any adjacent two of the four magnetic poles have different polarities. In the case where two adjacent magnetic poles is regarded as a dipole, and the other two magnetic poles is regarded as another dipole, magnetic fields generated by those two dipoles act in opposite directions. Therefore, the quadrupole magnetic-field generation portion 60 generates a magnetic field, which influences the width, height, etc., of an electron beam. The “width” and “height” of the electron beam are not related to the spatial location of the X-ray tube 30; i.e., the width is a length of the focal spot of the electron beam in a direction perpendicular to the tube axis TA (that is nearly parallel to the traveling direction of the electron beam), and the height is a length of the focal spot in a direction intersecting the above direction. In the first embodiment, in the quadrupole magnetic-field generation portion 60, the four magnetic poles 68 are arranged in the manner of a square. Although it will be explained in detail later, in the quadrupole magnetic-field generation portion 60, the magnetic poles 68a, 68b, 68c and 68d are provided at distal ends of the projecting portions 66a, 66b, 66c and 66d projecting from the main body portion of the yoke 66.

When the coils 64 are supplied with current from a power source (not shown) for the quadrupole magnetic-field generation portion 60, they generate magnetic fields. In the first embodiment, the coils 64 are supplied with a direct current from the power source (not shown). The coils 64 are provided as the coils 64a, 64b, 64c and 64d. The coils 64a to 64d are wound around portions of the projecting portions 66a to 66d of the yoke 66, which will be described later.

The projecting portions 66a, 66b, 66c and 66d of the yoke 66 project from the main body portion thereof. The projecting portions 66a to 66d are provided to project in the traveling direction of an electron beam or a direction parallel to the central line extending through the center of the cathode 36. The projecting portions 66a to 66d project in the same direction, and are parallel to each other. Also, the projecting portions 66a to 66d have the same length and the same shape. As shown in FIG. 2E, for example, the yoke 66 is provided coaxial with the cathode 36. Also, the main body portion of the yoke 66 is formed in the shape of a hollow polygon or a hollow cylinder. In the first embodiment, the yoke 66 is provided such that the four projecting portions 66a to 66d are located in the recessed portions 32a to 32d. At this time, the yoke 66 is provided such the four projecting portions 66a to 66d surround the cathode 36. Also, the periphery of part of each of the four projecting portions is wound with an associated one of the coils 64, and the part of each projecting portion surrounds the cathode 36.

To be more specific, the periphery of part of the projecting portion 66a of the yoke 66 is wound with the coil 64a, and the part of the projecting portion 66a surrounds the cathode 36. Similarly, the peripheries of parts of the projecting portions 66b, 66c and 66d are wound with the coils 64b, 64c and 64d, and the parts of the projecting portions 66b, 66c and 66d surround the cathode 36.

The yoke 66 is formed of a material having a soft magnetic property and high electrical resistance in which ddycurrent is not easily generated by an alternating magnetic field. For example, it is formed of a laminated body in which a thin plate and electrically insulating films holding the thin plate interposed therebetween are stacked together, the thin plate being formed of an Fe—Si alloy (silicon steel), an Fe—Al alloy, electromagnetic stainless steel, an Fe—Ni high magnetic permeability alloy such as permalloy, an Ni—Cr alloy, an Fe—Ni—Cr alloy, an Fe—Ni—Co alloy, a Fe—Cr alloy or the like. Alternatively, it is formed of, for example, an aggregation in which a wire rod formed of any of those materials is covered by an electrically insulating film, and they are combined and hardened. Furthermore, the yoke 66 may be formed of, for example, a compact which is obtained by reducing the above-mentioned material to fine powder having approximately 1 μm, covering the surface thereof with an electrically insulating film, and then subjecting it to compression molding. Also, the yoke 66 may be formed of soft ferrite or like.

The magnetic poles 68 are provided as the magnetic poles 68a, 68b, 68c and 68d. The magnetic poles 68a, 68b, 68c and 68d are provided at distal end portions of the projecting portions 66a, 66b, 66c and 66d of the yoke 66. The magnetic poles 68a to 68d are arranged in such a manner as to surround the cathode 36. That is, in the quadrupole magnetic-field generation portion 60, the magnetic poles 68a to 68d are equally spaced from each other in a direction perpendicular to the traveling direction (orbit) of electrons emitted from the filament included in the cathode 36.

For example, as in the above recessed portions 32a to 32d, as shown in FIG. 2B, the magnetic pole 68a is provided on a line which is rotated (in the counter-clockwise direction) by 45° from line L1 around the center of the cathode 36; the magnetic pole 68b is provided in a location which is rotated by 90° from the magnetic pole 68a around the center of the cathode 36; the magnetic pole 68d is provided in a location which is rotated through 90° from the magnetic pole 68b around the center of the cathode 36; and the magnetic pole 68c is provided in a location which is rotated through 90° from the magnetic pole 68d around the center of the cathode 36. That is, the magnetic poles 68a to 68d are located on vertices of a square, respectively.

In order to increase magnetic flux density, it is preferable that the magnetic poles 68a to 68d be provided close to the traveling direction (orbit) of electrons emitted from the filament included in the cathode 36. To be more specific, the magnetic pole 68a is located close to the corner portion of the recessed portion 32a. Similarly, the magnetic poles 68b to 68d are located close to the corner portions of the recessed portions 32b to 32d, respectively.

The magnetic poles 68a to 68d are formed to have substantially the same shape. The magnetic poles 68a to 68d are also paired as two dipoles. For example, the magnetic poles 68a and 68b are paired as a dipole (a pair of magnetic poles 68a and 68b), and the magnetic poles 68c and 68d are paired as a dipole (a pair of magnetic poles 68c and 68d). At this time, in the case where a direct current is supplied to the magnetic pole 68 through the coil 64, the pair of magnetic poles 68a and 68b and the pair of magnetic poles 68c and 68d generate direct-current magnetic fields which act in opposite directions. The magnetic poles 68a to 68d are provided not too close to the anode target 35 and the cathode 36, and also located such that their surfaces (end faces) face a line, i.e., a path along which an electron beam emitted from the cathode 36 travels, in order to increase the magnetic flux density and deform the shape of the electron beam emitted from the cathode 36. That is, the magnetic poles 68a to 68d are inclined at a predetermined angle such that their surfaces faces the above traveling path of the electron beam.

For example, in the case where the traveling direction of the electron beam emitted from the cathode 36 is parallel to the tube axis TA, the magnetic poles 68a to 68d are inclined at the same angle with respect to the traveling path of the electron beam. As shown in FIG. 2C, the angle between the line (extending along the tube axis TA in the figure) along the traveling direction of the electron beam which is parallel to the tube axis TA and the surface of the magnetic pole 68a is denoted by γ1, and also the angle between the line along the traveling direction of the electron beam and the surface of the of the magnetic pole 68d is denoted by γ4. As shown in FIG. 2D, the angle between the line (extending along the tube axis TA in the figure) along the traveling direction of the electron beam which is parallel to the tube axis TA and the surface of the magnetic pole 68b is denoted by γ2, and also the angle between the line along the traveling direction of the electron beam and the surface of the magnetic pole 68c is denoted by γ3. Therefore, for example, in the case where the magnetic poles 68a to 68d are inclined at the same angle, γ1=γ2=γ3=γ4. In this case, the angle γ at which each magnetic pole is inclined (the angles γ1, γ2, γ3 and γ4 at which the magnetic poles 68a to 68d are inclined) with respect to the traveling direction of the electron beam is set such that 0°<γ<90°. For example, in the case where the inclined angles γ1, γ2, γ3 and γ4 of the magnetic poles 68a to 68d are equal to each other, the inclined angle γ of each of the magnetic poles 68a to 68d is set such that 30°≦γ≦60°. Furthermore, the inclined angles γ1, γ2, γ3 and γ4 of the magnetic poles 68a to 68d with respect to the traveling direction of the electron beam may be set to 45°.

A principle of the quadrupole magnetic-field generation portion 60 according to the first embodiment will be explained with reference to the accompanying drawings.

FIG. 3 is a view showing the principle of the quadrupole magnetic-field generation portion 60 according to the first embodiment. Referring to FIG. 3, X and Y directions are directions perpendicular to the traveling direction of the electron beam, and also intersect each other. Also, the X direction is a direction from the magnetic pole 68d (the magnetic pole 68c) toward the magnetic pole 68b (the magnetic pole 68a), and the Y direction is a direction from the magnetic pole 68d (the magnetic pole 68b) toward the magnetic pole 68c (the magnetic pole 68a).

Referring to FIG. 3, which is a plan view, i.e., as seen from above, electron beam BM1 travels from below toward above. Suppose when electron beam BM1 is emitted, it has a circular cross section. Also, referring to FIG. 3, the magnetic pole 68a generates an N-pole magnetic field; the magnetic pole 68b generates an S-pole magnetic field; the magnetic pole 68d generates an N-pole magnetic field, and the magnetic pole 68c generates an S-pole magnetic field. In such a case, the magnetic pole 68a generates a composite magnetic field which acts toward the magnetic poles 68c and 68b, and the magnetic pole 68d generates a composite magnetic field which acts toward the magnetic poles 68c and 68b. In the case where electron beam BM1 travels through the center of space surrounded by the magnetic poles 68a to 68d, it is deformed by Lorentz force of the generated composite magnetic field such that it shrinks in the X direction and in the opposite direction to the X direction and also expands in the Y direction and the opposite direction to the Y direction. As a result, as shown in FIG. 3, the cross section of electron beam BM1 is changed to an oval having its major axis along the Y direction and its minor axis along the X direction.

In the embodiment, in the case where the X-ray tube assembly 10 is driven, an electron beam is emitted from the filament included in the cathode 36 toward a focal point on the anode target 35. Suppose that the electron beam travels along the central line extending through the center of the cathode 36. Furthermore, the inclined angles γ1 to γ4 of the magnetic poles 68a to 68d of the quadrupole magnetic-field generation portion 60 as shown in FIGS. 2C and 2D are equal to each other. In the quadrupole magnetic-field generation portion 60, the coils 64 are supplied with direct current, from the power supply not shown. When supplied with direct current from the power supply, the quadrupole magnetic-field generation portion 60 generates composite magnetic field between the magnetic poles 68a to 68d, which correspond the quadrupole. The electron beam emitted from the cathode 36 collides with the anode target 35 along the tube axis TA in such a manner as to cross the magnetic field generated between the cathode 36 and the anode target 35. At this time, the electron beam is shaped (deformed) by the magnetic field generated by the quadrupole magnetic-field generation portion 60. In the embodiment, for example, as shown in FIG. 3, the quadrupole magnetic-field generation portion 60 alters (deforms) the cross section of an electron beam having a circular cross section into an oval which is elongate in the Y direction. In this case, the quadrupole magnetic-field generation portion 60 can make small the effective focal spot of the electron beam, and also make wide an actual focal spot of the electron beam actually colliding with the surface of the anode target 35. As a result, the thermal load to the target 35 is reduced.

According to the embodiment, the X-ray tube assembly 10 comprises the X-ray tube 30, which is provided with the recessed portions 32a to 32d and the quadrupole magnetic-field generation portion 60, which shapes the electron beam emitted from the X-ray tube 30. When direct current is supplied from the power supply to the coil 64, the quadrupole magnetic-field generation portion 60 generates a magnetic field between the magnetic poles 68a to 68d. The quadrupole magnetic-field generation portion 60 can deform the electron beam emitted from the cathode 36 because of the magnetic field generated by the magnetic poles 68a to 68d. As a result, the X-ray tube assembly 10 according to the first embodiment can reduce occurrence of enlargement, blurring or distortion of the focal spot of the electron beam, and lowering of the number of electrons emitted from the cathode 36, etc.

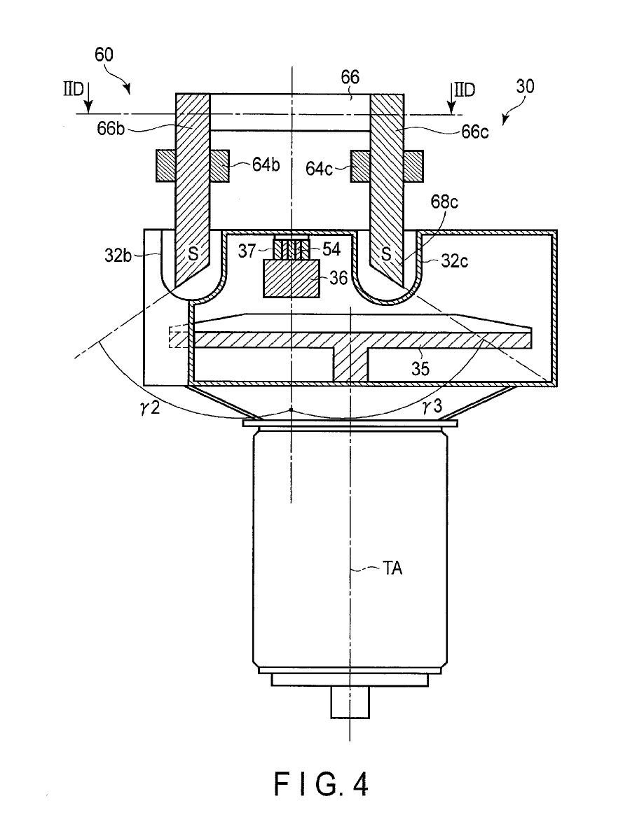

It should be noted that in the magnetic poles 68a to 68d, the distal end portions of the projecting portions 66a to 66d of the yoke 66 may be formed to be inclined diagonally. For example, as shown in FIG. 4, the distal end portions of the projecting portions 66b and 66c of the magnetic poles 68b and 68c are formed to be inclined diagonally such that their surfaces face the line extending along the traveling direction of the electron beam, i.e., the travelling path of the electron beam. In this case, the magnetic poles 68a to 68d may be provided such that normals extending from the centers of the magnetic poles 68a to 68d along the above facing directions of the surfaces of the magnetic poles 68a to 68d intersect each other at a single point.

X-ray tube assemblies according to the other embodiments will be explained. In the other embodiments, elements identical to those in the above first embodiment will be denoted by the same reference numerals as in the first embodiment, and their detailed explanations will be omitted.

### Second Embodiment

Besides the configuration of the X-ray tube assembly 10 of the first embodiment, the X-ray tube assembly 10 of the second embodiment further comprises deflection coil portions for deflecting an electron beam.

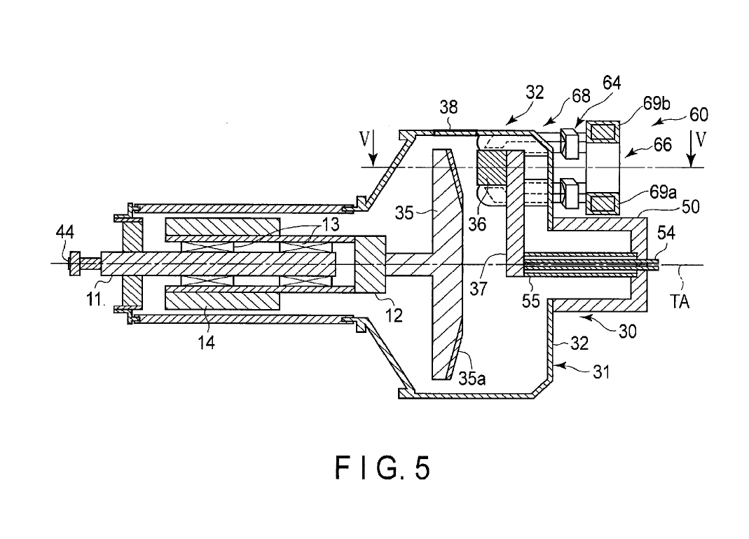

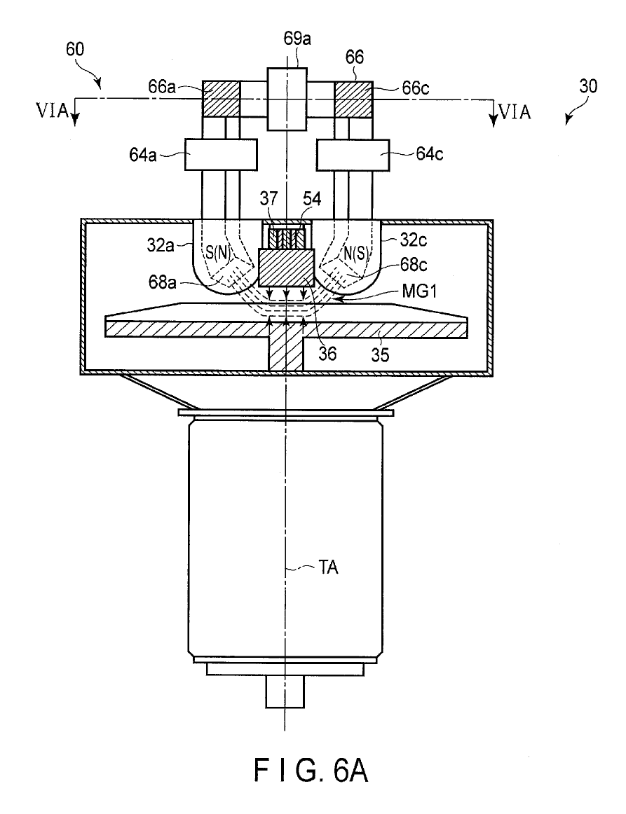

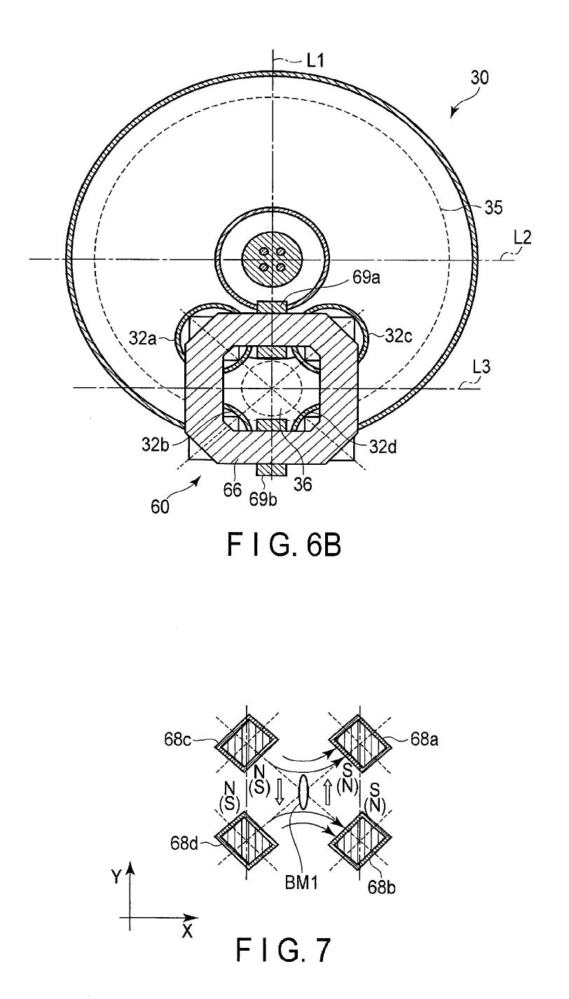

FIG. 5 is a cross-sectional view schematically showing the X-ray tube assembly according to the second embodiment; FIG. 6A is a cross-sectional view taken along line V-V in FIG. 5; and FIG. 6B is a cross-sectional view taken along line VIA-VIA in FIG. 6A.

As shown in FIG. 5, a quadrupole magnetic-field generation portion 60 in the second embodiment further comprises deflection coil portions 69a and 69b (first and second deflection coil portions) in addition to the structural elements of the quadrupole magnetic-field generation portion 60 in the first embodiment.

The quadrupole magnetic-field generation portion 60 of the second embodiment generates a dipole alternating magnetic field in which magnetic fields generated by two dipoles located opposite to each other act in the same direction. For example, the quadrupole magnetic-field generation portion 60 comprises a pair of magnetic poles 68a and 68c and a pair of magnetic poles 68b and 68d. The pair of magnetic poles 68a and 68c and the pair of magnetic poles 68b and 68d generate magnetic fields as dipoles, respectively. As shown in FIG. 6A, the pair of magnetic poles 68a and 68c generate a magnetic field (alternating magnetic field MG1) between them.

When supplied with alternating current, the quadrupole magnetic-field generation portion 60 can intermittently or continuously deflect the orbit of electrons because of the alternating magnetic field generated by the magnetic poles serving as the dipole. In the quadrupole magnetic-field generation portion 60, alternating current to be supplied from a power supply (not shown) to each of the deflection coil portions 69a and 69b, which will be described later, is controlled by a deflection power supply controller (not shown), such that the focal spot of an electron beam which is emitted from a cathode 36 and collides with the surface of an anode target 35 is intermittently or continuously shifted. The quadrupole magnetic-field generation portion 60 can deflect the electron beam emitted from the cathode 36 in a direction along the radius direction of the anode target 35. That is, the quadrupole magnetic-field generation portion 60 can shift the focal spot of the electron beam colliding with the surface of the target 35.

The deflection coil portions 69a and 69b are electromagnetic coils which are supplied with current from a power supply (not shown), and generate magnetic fields. In the second embodiment, the deflection coil portions 69a and 69b are supplied with alternating current from the power supply, and generate alternating magnetic fields. The deflection coil portions 69a and 69b are each wound around any part of a main body of a yoke 66, which is located between associated two of projecting portions 66a to 66d of the yoke 66. As shown in FIG. 6B, the deflection coil portion 69a is wound around part of the main body of the yoke 66 which is located between the projecting portions 66a and 66c. The deflection coil portion 69b is wound around part of the main body of the yoke 66 which is located between the projecting portions 66b and 66d. In this case, the pair of magnetic poles 68a and 68c generate an alternating magnetic field between them, and the pair of magnetic poles 68b and 68d generate an alternating magnetic field between them.

The deflection coil portions 69a and 69b generate a dipole magnetic field along a line which corresponds to the rotation direction of the anode target 35. The deflection coil portions 69a and 69b can intermittently or continuously deflect the orbit of the electron beam along the radius direction of the anode target because of alternating current which is flowing.

The quadrupole magnetic-field generation portion 60 of the second embodiment will be explained with reference to the accompanying drawings.

FIG. 7 is a view showing the principle of the quadrupole magnetic-field generation portion 60 according to the second embodiment. Referring to FIG. 7, X and Y directions are directions perpendicular to the traveling direction of an electron beam, and also intersect each other. Also, the X direction is a direction from the magnetic pole 68d (the magnetic pole 68c) toward the magnetic pole 68b (the magnetic pole 68a), and the Y direction is a direction from the magnetic pole 68d (the magnetic pole 68b) toward the magnetic pole 68c (the magnetic pole 68a).

Referring to FIG. 7, which is a plan view, i.e., as seen from above, electron beam BM1 travels from below toward above. Also, referring to FIG. 7, the magnetic poles 68a and 68c are paired as a dipole (a pair of magnetic poles), and the magnetic poles 68b and 68d are paired as a dipole (a pair of magnetic poles). The pair of magnetic poles 68a and 68c generate an alternating magnetic field acting in the X direction, and the pair of magnetic poles 68b and 68d also generate another alternating magnetic acting in the X direction.

The quadrupole magnetic-field generation portion 60 can intermittently or continuously deflect the electron beam in the Y direction because of alternating current flowing in the deflection coil portions 69a and 69b.

In the second embodiment, in the case where the X-ray tube assembly 10 is driven, an electron beam is emitted from the filament included in the cathode 36 toward the focal point on the anode target 35. Suppose that the electron beam travels along the central line extending through the center of the cathode 36. Furthermore, as shown in FIG. 2B, inclined angles γ1 to γ4 of the magnetic poles 68a to 68d of the quadrupole magnetic-field generation portion 60 are equal to each other. The quadrupole magnetic-field generation portion 60 is supplied with alternating current from the power supply not shown. When supplied from the power supply with alternating current, the quadrupole magnetic-field generation portion 60 generates magnetic fields between the pair of magnetic poles 68a and 68c serving as a dipole and between the pair of magnetic poles 68b and 68d serving as another dipole. In the second embodiment, the pair of magnetic poles 68a and 68c and the pair of magnetic poles 68b and 68d are provided to generate magnetic fields between the cathode 36 and the anode target 35. That is, the quadrupole magnetic-field generation portion 60 generates magnetic field between the cathode 36 and the anode target 35. Electrons emitted from the cathode 36 collide with the anode target 35 along the tube axis TA in such a manner as to cross the magnetic field generated between the cathode 36 and the anode target 35.

The quadrupole magnetic-field generation portion 60 can intermittently or continuously shift the electron beam passing through the magnetic field because of a control by the deflection power supply controller (not shown) over alternating current supplied from the power supply (not shown). To be more specific, because of the control of the supplied current with the deflection power supply controller, the quadrupole magnetic-field generation portion 60 deflects electrons (beam) emitted from the cathode 36 in the direction along the radius direction of the anode target 35. That is, the quadrupole magnetic-field generation portion 60 can shift a focal spot which is a point at the surface of the anode target 35 with which the electrons collides, because of the control by the deflection power supply controller over the supplied current.

While the quadrupole magnetic-field generation portion 60 is generating alternating current, a non-magnetic cover of the cathode 36 generates a magnetic field acting in the opposite direction to that of an alternating magnetic field on the basis of ddycurrent, since it is formed of a non-magnetic substance having high electrical conductivity. Similarly, the anode target 35 generates a magnetic field which acts in the opposite direction to that of the alternating magnetic field on the basis of ddycurrent, since it is formed of a non-magnetic substance having high electrical conductivity. The alternating magnetic field is distorted by the magnetic fields which are generated by the non-magnetic cover and the anode target 35, and which act in the opposite direction to the alternating magnetic field. As a result, as shown in FIG. 6A, for example, alternating magnetic field MG1 acts in a direction substantially perpendicular to the traveling direction of the electron beam, between the surface of the anode target 35 and the surface of the cathode 36. Also, as a result of distortion of alternating magnetic field MG1, the intensity (magnetic flux density) of part of alternating magnetic field MG1 which is located close to a region between the surfaces of the anode target 35 and the cathode 36 is enhanced. As a result, the deflecting force of the quadrupole magnetic-field generation portion 60 for electrons (beam) is also enhanced, and the quadrupole magnetic-field generation portion 60 can thus efficiently deflect electrons (beam).

According to the second embodiment, the X-ray tube assembly 10 comprises an X-ray tube 30, which is provided with recessed portions 32a to 32d and the quadrupole magnetic-field generation portion 60, which deflects electrons emitted from the X-ray tube 30. The quadrupole magnetic-field generation portion 60 generates a magnetic field between the cathode 36 and the anode target 35 with the magnetic poles 68a to 68d. Surfaces of the magnetic poles 68a to 68d are inclined at a predetermined angle with respect to the traveling direction of an electron beam emitted from the cathode 36, in order to deflect the electron beam between the anode target 35 and the cathode 36. In the vacuum envelope 31 of the X-ray tube 30, at a peripheral portion of the cathode 36, the non-magnetic cover is provided which is formed of a non-magnetic metallic material having high electrical conductivity. Also, the anode target 35 is formed of a non-magnetic metallic material having high electrical conductivity. Therefore, when alternating current is supplied to the quadrupole magnetic-field generation portion 60, part of an alternating magnetic field generated by the quadrupole magnetic-field generation portion 60 is strengthened. As a result, the quadrupole magnetic-field generation portion 60 can reliably deflect electrons emitted from the cathode 36.

Furthermore, in the X-ray tube assembly 10, no small-diameter portion is provided between the anode target 35 and the cathode 36. Thus, the anode target 35 and the cathode 36 can be provided closer to each other. As a result, the X-ray tube assembly 10 according to the second embodiment can restrict occurrence of enlargement, blurring or distortion of the focal spot of the electron beam, and lowering of the number of electrons emitted from the cathode 36, etc.

A modification of the second embodiment will be explained with reference to the accompanying drawings. An X-ray tube assembly 10 according to the modification has substantially the same structure as the X-ray tube assembly 10 according to the second embodiment. Thus, the X-ray tube assembly 10 in the modification, elements identical to those in the X-ray tube assembly 10 according to the second embodiment will be denoted by the same reference numerals as in the second embodiment, and their detailed explanations will be omitted.

(Modification 1)

In an X-ray tube assembly 10 according to modification 1 of the second embodiment, deflection coils are provided in locations which are rotated around a cathode 36 through 90° with respect to deflection coil portions 69a and 69b provided as explained as regards the second embodiment.

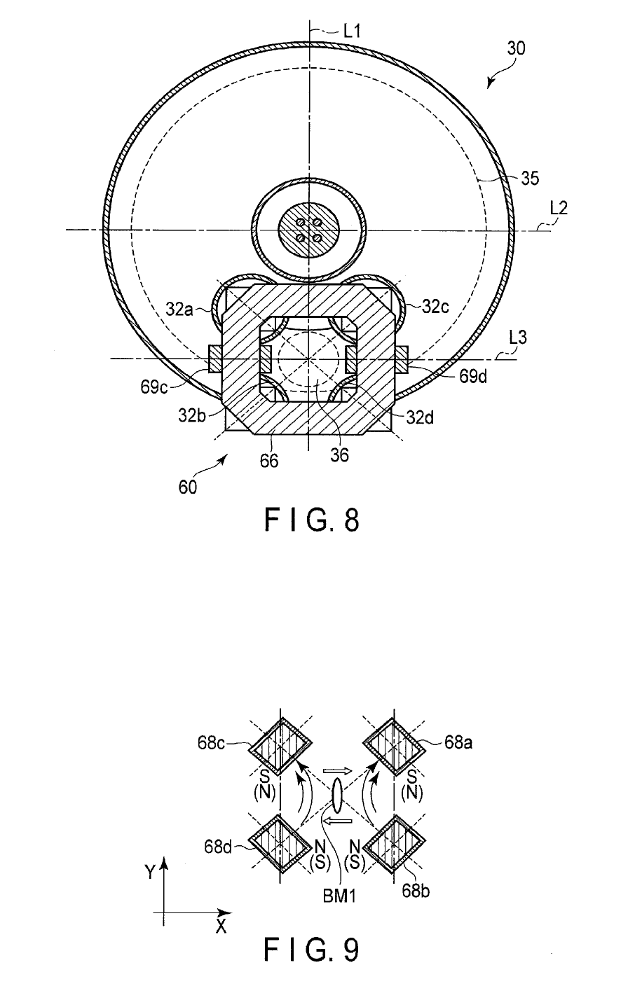

FIG. 8 is a cross-sectional view schematically showing an X-ray tube 30 according to modification 1.

As shown in FIG. 8, in modification 1, a quadrupole magnetic-field generation portion 60 further comprises deflection coil portions 69c and 69d (third and fourth deflection coil portions) in addition to the structural elements of the quadrupole magnetic-field generation portion 60 of the second embodiment.

When supplied with current from a power supply (not shown), the deflection coil portions 69c and 69d generate magnetic fields. To be more specific, in modification 1, the deflection coil portions 69c and 69d are supplied with alternating current from the power supply, and generate alternating magnetic fields. The deflection coil portions 69c and 69d are each wound around any part of a main body of a yoke 66, which is located between associated two of projecting portions 66a to 66d of a yoke 66. As shown in FIG. 6B, the deflection coil portion 69c is wound around part of the main body of the yoke 66 which is located between the projecting portions 66a and 66b. The deflection coil portion 69d is wound around part of the main body of the yoke 66 which is located between the projecting portions 66c and 66d. In this case, a pair of magnetic poles 68a and 68b generate an alternating magnetic field between them, and a pair of magnetic poles 68c and 68d generate an alternating magnetic field between them.

The deflection coil portions 69c and 69d generate a dipole magnetic field along a line which corresponds to the radius direction of the anode target 35. The deflection coil portions 69c and 69d can deflect the orbit of the electron beam in a predetermined direction because of flowing alternating current.

A principle of the quadrupole magnetic-field generation portion 60 of modification 1 will be explained with reference to the accompanying drawings.

FIG. 9 is a view showing the principle of the quadrupole magnetic-field generation portion 60 according to modification 1. Referring to FIG. 9, X and Y directions are directions perpendicular to the traveling direction of an electron beam, and also intersect each other. Also, the X direction is a direction from a magnetic pole 68d (magnetic pole 68c) toward a magnetic pole 68b (magnetic pole 68a), and the Y direction is a direction from a magnetic pole 68d (magnetic pole 68b) toward the magnetic pole 68c (magnetic pole 68a).

Referring to FIG. 9, i.e., as seen from above, electron beam BM1 travels from below toward above. Also, referring to FIG. 9, the magnetic poles 68a and 68b are paired as a dipole (a pair of magnetic poles), and the magnetic poles 68c and 68d are paired as a dipole (a pair of magnetic poles). The pair of magnetic poles 68a and 68b generate an alternating magnetic field acting in the Y direction, and the pair of magnetic poles 68c and 68d also generate another alternating magnetic acting in the Y direction.

The quadrupole magnetic-field generation portion 60 can shift the electron beam in the X direction because of alternating current flowing in the deflection coil portions 69c and 69d.

According to modification 1, the quadrupole magnetic-field generation portion 60 comprises deflection coil portions 69c and 69d on a line in the main body of the yoke 66, which is perpendicular to a line extending between the deflection coil portions 69a and 69b provided as explained with reference to the second embodiment. Therefore, the X-ray tube assembly 10 according to modification 1 can deflect the electron beam in a direction perpendicular to the direction explained with reference to the second embodiment.

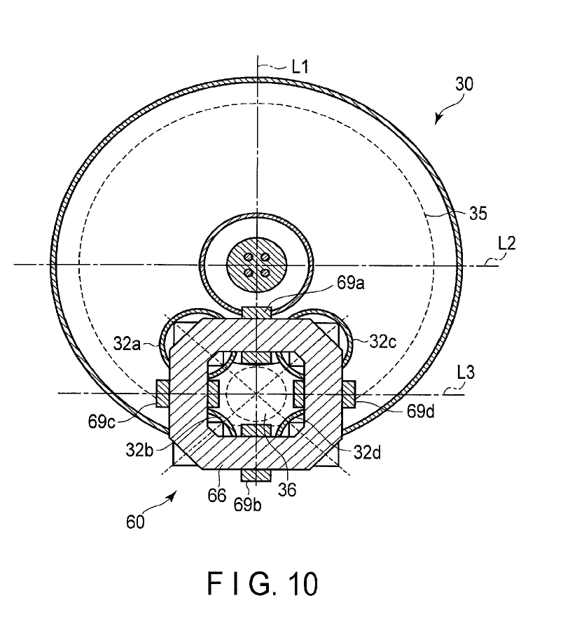

It should be noted that as shown in FIG. 10, in the quadrupole magnetic-field generation portion 60, the deflection coil portions 69a to 69d may be provided in the main body of the yoke 66. In this case, the quadrupole magnetic-field generation portion 60 can shift the electron beam in the X direction and/or the Y direction, or arbitrarily shift the electron beam in a direction perpendicular to the traveling direction (orbit) of the electron beam, by changing the ratio between current flowing in the deflection coil portions 69a to 69d.

According to the above embodiments, the X-ray tube assembly 10 comprises an X-ray tube, which is provided with a plurality of recessed portions and the quadrupole magnetic-field generation portion, which shapes the electron beam generated from the X-ray tube 30. When direct current is supplied from the power supply to the coils, the quadrupole magnetic-field generation portion generates magnetic fields between the magnetic poles. The quadrupole magnetic-field generation portion can deform the electron beam emitted from the cathode 36 because of the magnetic field generated by the magnetic poles. As a result, the X-ray tube assembly 10 according to the above embodiments can restrict occurrence of enlargement, blurring or distortion of the focal spot of the electron beam, and lowering of the number of electrons emitted from the cathode, etc.

Further, when alternating current is simultaneously supplied from the power supply to the deflection coils, the quadrupole magnetic-field generation portion can also deflect the electron beam emitted from the cathode 36 intermittently or continuously.

It should be noted that with respect to the above embodiments, although it is explained above that the X-ray tube assembly 10 is a rotation anode X-tube assembly, it may be provided as a stationary anode X-ray tube assembly.

Also, with respect to the above embodiments, although it is explained above that the X-ray tube assembly 10 is a neutral-point grounded type of X-ray tube assembly, it may be provided as an anode grounded type of X-ray tube or a cathode grounded type of X-ray tube assembly.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Furthermore, various inventions can be made by appropriately combining a plurality of structural elements described with respect to any of the above embodiments. For example, some structural elements may be deleted from all the structural elements described with respect to any of the embodiments. In addition, structural elements of a plurality of embodiments as explained above may be combined as appropriate.

What is claimed is:

1. An X-ray tube assembly comprising:
a cathode which emits electrons in an electron orbit direction;
an anode target provided opposite to the cathode and including a target surface with which electrons emitted from the cathode collides to generate X-rays;
a vacuum envelope which contains the cathode and the anode target, which is vacuum-tightly closed, and in which at least one recessed portion is formed to be recessed from the outside of the vacuum envelope in such a way as to surround the cathode; and
a quadrupole magnetic-field generation portion which is supplied with direct current by a DC power supply, and provided outside the vacuum envelope, and which comprises four poles provided in the at least one recessed portion such that the cathode is located in a center of an area surrounded by the four poles.

2. The X-ray tube assembly of claim 1, further comprising at least one deflection coil portion which is supplied with alternating current from an AC power supply, and provided at part of the quadrupole magnetic-field generation portion, and which comprises at least a pair of dipoles which generate alternating magnetic fields at the four poles.

3. The X-ray tube assembly of claim 2, wherein:
the cathode is formed of a first metallic material in which at least a surface portion thereof has a high electrical conductivity and is non-magnetic; and
the anode target is formed of a second metallic material in which at least a surface portion thereof has a high electrical conductivity and is non-magnetic.

4. The X-ray tube assembly of claim 3, wherein the first and second metallic materials are any of copper, tungsten, molybdenum, niobium, tantalum, a non-magnetic stainless steel, titanium and chromium, or non-magnetic metallic materials which contain any of copper, tungsten, molybdenum, niobium, tantalum, a non-magnetic stainless steel, titanium and chromium as main ingredients of the first and second metallic materials.

5. The X-ray tube assembly of claim 1, wherein:
the quadrupole magnetic-field generation portion includes four poles having end faces which are inclined at a predetermined angle γ with respect to an electron orbit; and
the angle γ is set such that 0°<γ<90°.

6. The X-ray tube assembly of claim 1, wherein the at least one recessed portion is located further away from the anode target than an end face of the cathode in a direction along the electron orbit.
